(19) United States
(12) Patent Application Publication
(10) Pub. No.: US 2026/0118503 A1
(43) Pub. Date: Apr. 30, 2026

(54) SECURITY IN ULTRA-WIDEBAND RANGING SYSTEMS

(71) Applicant: GM GLOBAL TECHNOLOGY OPERATIONS LLC, Detroit, MI (US)

(72) Inventors: Ahmed F. Al Alawy, Canton, MI (US); Vikas Vemuri, Farmington Hills, MI (US); Mohamed A. Layouni, Fraser, MI (US)

(73) Assignee: GM GLOBAL TECHNOLOGY OPERATIONS LLC, Detroit, MI (US)

(21) Appl. No.: 18/928,933

(22) Filed: Oct. 28, 2024

(51) Int. Cl. G01S 13/88; B60R 25/01; B60R 25/24; G01S 13/02

(52) U.S. Cl. CPC G01S 13/88; B60R 25/01; B60R 25/245; G01S 13/0209

(57) ABSTRACT

A method for determining a distance between a transmitter and a receiver including storing, in a memory, a first data indicative of characteristics of an expected peak, receiving, by the receiver, a data sequence including a first peak and a second peak, authenticating, by a processor, the data sequence in response to a second data received in the second peak, determining, by the processor, a distance between a transmitter and the vehicle communications system in response to a difference between a first time of reception of the first peak and a second time of reception of the second peak, wherein a determination of the distance is initiated in response to the first peak matching the expected peak, and enabling, by a vehicle controller, a vehicle control algorithm in response to the distance.

### INTRODUCTION

The present disclosure relates to computer network security, and in particular, to secure ranging technologies. More specifically, aspects of this disclosure relate to systems, methods and devices to proactively identify and mitigate potential distance reduction attacks on ranging protocols that use Ultra-Wideband (UWB).

The increasing complexity and connectivity of modern vehicles have increased the appeal of hardening these vehicles to electronic attacks. The proliferation of features such as infotainment systems, telematics, and autonomous driving capabilities has expanded the attack surface, creating new opportunities for malicious actors to exploit. Additionally, the reliance on complex embedded systems and software can introduce vulnerabilities that attackers can leverage. Weak security measures, shared components, a lack of cybersecurity awareness within the automotive industry, and regulatory challenges further exacerbate the risk of electronic attacks on modern vehicles.

Ghost peak attacks and other ranging system attacks pose a significant security challenge to Ultra-Wideband (UWB) ranging systems. These attacks exploit the unique characteristics of UWB signals, namely their wide bandwidth and short pulse duration, to inject false signals or “ghost peaks” into the communication channel. This manipulation can lead to inaccurate distance measurements, potentially compromising the security and reliability of the system. Ghost peak attacks can have devastating consequences, including unauthorized access to restricted areas or devices, location spoofing, and interference with other devices that rely on UWB signals. Malicious actors can exploit inaccurate distance measurements to gain access to secure areas or devices that are normally restricted to authorized personnel, or to manipulate the location information provided by UWB ranging systems. This could lead to a variety of harmful consequences, such as inaccurate navigation, tracking errors, and even physical harm. Additionally, ghost peak attacks can disrupt the operation of other devices that use UWB signals, such as radar systems, wireless communications networks, and medical devices. This could have serious consequences for safety, security, and economic activity.

To mitigate the risks associated with ghost peak attacks, UWB ranging systems can typically employ a combination of robust signal processing algorithms, cryptographic techniques, and physical countermeasures. Advanced signal processing techniques can help to identify and filter out false signals, improving the accuracy and reliability of distance measurements. Cryptographic methods can protect the integrity and confidentiality of UWB communications, making it more difficult for attackers to inject false signals. Physical measures such as shielding, antenna diversity, and frequency hopping can also be used to reduce the vulnerability of UWB systems to ghost peak attacks.

Accordingly, it would be desirable to provide systems, methods and mechanisms to proactively identify and mitigate potential identify and mitigate potential distance reduction attacks on UWB ranging. More precisely, it would be desirable to provide mechanisms for access control, data integrity and source authentication, denial of service prevention, and use of hardware to implement the above mechanisms efficiently. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle control systems and methods and related control logic for provisioning vehicle security systems, methods for making and methods for operating such systems, and vehicles equipped with distributed computing systems. By way of example, and not limitation, there are presented various embodiments of systems for providing a secure UWB ranging system in a motor vehicle data communications system disclosed herein.

In accordance with an aspect of an exemplary embodiment, a method for determining a distance between a transmitter and a receiver including storing, in a memory, a first data indicative of characteristics of an expected peak, receiving, by the receiver, a data sequence including a first peak and a second peak, authenticating, by a processor, the data sequence in response to a second data received in the second peak, determining, by the processor, the distance between the transmitter and the receiver in response to a difference between a first time of reception of the first peak and a second time of reception of the second peak, wherein a determination of the distance is initiated in response to the first peak matching the expected peak, and enabling, by a vehicle controller, a vehicle control algorithm in response to the distance.

In accordance with another aspect of an exemplary embodiment wherein a search time interval for detecting a subsequent first peak is reduced in response to the first peak not matching the expected peak.

In accordance with another aspect of an exemplary embodiment wherein the first peak and the second peak are a portion of a pseudorandom spread spectrum time hopping sequence.

In accordance with another aspect of an exemplary embodiment wherein the vehicle control algorithm includes unlocking a vehicle and transitioning the vehicle between a standby state and an on state.

In accordance with another aspect of an exemplary embodiment wherein a search time interval for detecting a subsequent first peak is reduced in response to the first peak not matching the expected peak, and wherein a duration of the search time interval is determined in response to a vehicle location, a vehicle environment, a weather condition, a user habit and a potential risk level.

In accordance with another aspect of an exemplary embodiment wherein a search time interval for detecting a subsequent first peak is reduced in response to the first peak not matching the expected peak, and wherein a duration of the search time interval is determined in response to a level of multipath estimated in response to transmitting a signal and detecting a reflection of the signal by a vehicle communications system.

In accordance with another aspect of an exemplary embodiment wherein a search time interval for detecting a subsequent first peak is reduced in response to the first peak not matching the expected peak, and wherein a duration of the search time interval is reduced in response to a length of pseudorandom spread spectrum time hopping sequence preamble in a time domain.

In accordance with another aspect of an exemplary embodiment wherein the first peak is rejected in response to the first peak not matching the expected peak and a subsequent peak is detected between the first peak and the second peak wherein the subsequent peak is then compared to the expected peak.

In accordance with another aspect of an exemplary embodiment wherein a power difference between the first peak and the second peak is used to compare the first peak to the expected peak.

In accordance with another aspect of an exemplary embodiment, an apparatus for determining a distance between a transmitter and a receiver including a memory configured for storing a first data indicative of characteristics of an expected peak, the receiver configured for receiving a data sequence including a first peak and a second peak from the transmitter, a processor configured for authenticating the data sequence in response to a second data received in the second peak, for determining the distance between the transmitter and the receiver in response to a difference between a first time of reception of the first peak and a second time of reception of the second peak, wherein a determination of the distance is initiated in response to the first peak matching the expected peak, and for generating a control signal in response to the distance, and a vehicle controller for enabling a vehicle control algorithm in response to the control signal.

In accordance with another aspect of an exemplary embodiment wherein the processor is further configured to reduce a search time interval for detecting a subsequent first peak in response to the first peak not matching the expected peak.

In accordance with another aspect of an exemplary embodiment wherein the processor is further configured to reduce a search time interval for detecting a subsequent first peak in response to the first peak not matching the expected peak, and wherein a duration of the search time interval is determined in response to a vehicle location, a vehicle environment, a weather condition, a user habit and a potential risk level.

In accordance with another aspect of an exemplary embodiment wherein the processor is further configured to reduce a search time interval for detecting a subsequent first peak in response to the first peak not matching the expected peak, and wherein a duration of the search time interval is determined in response to a level of multipath estimated in response to transmitting a signal and detecting a reflection of the signal by a vehicle communications system.

In accordance with another aspect of an exemplary embodiment wherein the processor is further configured to reduce a search time interval for detecting a subsequent first peak in response to the first peak not matching the expected peak, and wherein a duration of the search time interval is reduced in response to a length of pseudorandom spread spectrum time hopping sequence preamble in a time domain.

In accordance with another aspect of an exemplary embodiment wherein the first peak is rejected in response to the first peak not matching the expected peak and a subsequent peak is detected between the first peak and the second peak wherein the subsequent peak is then compared to the expected peak.

In accordance with another aspect of an exemplary embodiment wherein a power difference between the first peak and the second peak is used to compare the first peak to the expected peak.

In accordance with another aspect of an exemplary embodiment wherein the first peak and the second peak are a portion of a pseudorandom spread spectrum time hopping sequence.

In accordance with another aspect of an exemplary embodiment wherein the vehicle control algorithm includes unlocking a vehicle and transitioning the vehicle between a standby state and an on state.

In accordance with another aspect of an exemplary embodiment, a vehicle communications system including a transmitter having a first memory for storing a shared key and for transmitting a pseudorandom spread spectrum time hopping sequence including a first peak and a second peak and wherein the second peak is generated in response to the shared key, a second memory for storing, a first data indicative of a plurality of characteristics of an expected peak wherein the plurality of characteristics include a time difference between the first peak and the second peak, a first power difference between the first peak and the second peak, and a second power difference between a leading edge of the first peak and a noise threshold, a receiver for receiving the pseudorandom spread spectrum time hopping sequence including the first peak and the second peak, a processor configured for authenticating the pseudorandom spread spectrum time hopping sequence in response to the second peak and the shared key, for determining a distance between the transmitter and the vehicle communications system in response to a difference between a first time of reception of the first peak and a second time of reception of the second peak, wherein a determination of the distance is initiated in response to the first peak matching the expected peak, and a vehicle controller configured for enabling a vehicle control algorithm in response to the distance and for controlling a vehicle in response to the vehicle control algorithm.

In accordance with another aspect of an exemplary embodiment wherein a search time interval for detecting a subsequent first peak is reduced in response to the first peak not matching the expected peak, and wherein a duration of the search time interval is determined in response to a vehicle location, a vehicle environment, a weather condition, a user habit, a potential risk level, a length of pseudorandom spread spectrum time hopping sequence preamble in a time domain, and a level of multipath estimated in response to transmitting a signal and detecting a reflection of the signal by the vehicle communications system. In accordance with another aspect of the exemplary embodiment of the present disclosure wherein

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an exemplary system for providing a secure UWB ranging system and a motor vehicle data communications system in accordance with embodiments of the present disclosure;

FIG. 2 is illustrative of a block diagram illustrating an exemplary implementation of a system for providing a secure UWB ranging system a motor vehicle data communications system according to an exemplary embodiment of the present disclosure;

FIG. 3 is illustrative of an exemplary function block diagram of a system providing a secure UWB ranging system a motor vehicle data communications system in a motor vehicle in accordance with embodiments of the present disclosure; and

FIG. 4 shows a flow chart illustrating an exemplary implementation of a method for providing a secure UWB ranging system a motor vehicle data communications system in accordance with embodiments of the present disclosure.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

In a motor vehicle application, where malicious actors seek to gain access to wireless vehicle communications and security systems, UWB ranging can be used to accurately determine distances between objects, such as the vehicle and a transmitter. For example, UWB ranging can be used to detect a distance between a vehicle and a key fob used to unlock and start a vehicle. Ghost peak attacks can be used to exploit the unique characteristics of UWB signals, malicious actors can inject false signals or “ghost peaks” into the communication channel, leading to inaccurate distance measurements. This can compromise the system's security and reliability, potentially enabling unauthorized access to restricted areas, location spoofing, and interference with other UWB-based devices. To mitigate these risks, UWB ranging systems typically employ a combination of robust signal processing algorithms, cryptographic techniques, and physical countermeasures to identify and filter out false signals, protect the integrity of communications, and reduce vulnerability to ghost peak attacks.

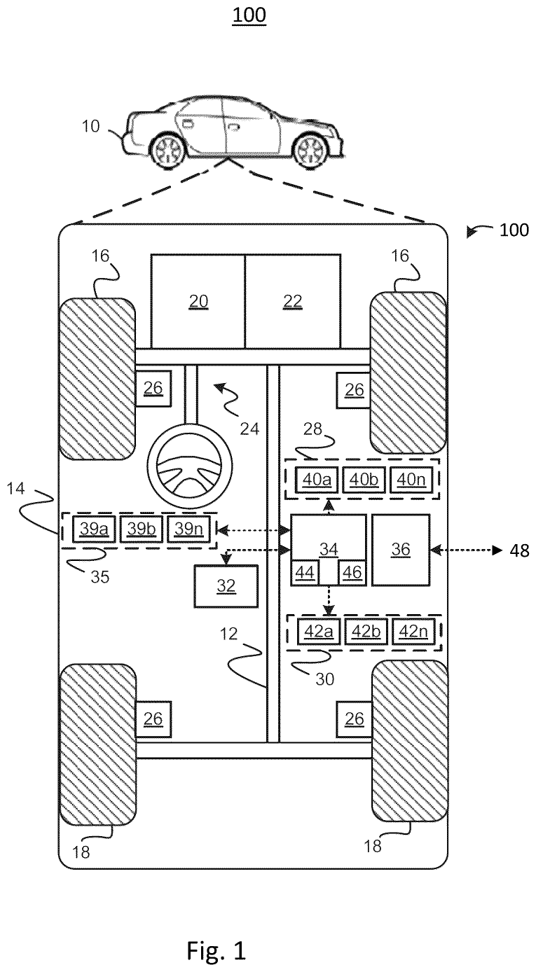

Turning now to FIG. 1, an exemplary system 100 for providing a secure UWB ranging system a motor vehicle data communications system is shown in accordance with various embodiments. The exemplary system 100 includes a vehicle 10 having a plurality of sensing devices 40a-40n, a propulsion system 20, a transmission system 22, a steering system 24, a brake system 26, a sensor system 28, an actuator system 30, at least one data storage device 32, at least one controller 34, and a communication system 36.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the control system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the vehicle 10 may be a non-autonomous vehicle and is not limited to the present examples.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors.

In various embodiments, the sensing devices 40a-40n are disposed at different locations of the vehicle 10. In exemplary embodiments described herein, one or more of the sensing devices 40-40n are realized as lidar devices. In this regard, each of the sensing devices 40a-40n may include or incorporate one or more lasers, scanning components, optical arrangements, photodetectors, and other components suitably configured to horizontally and rotatably scan the environment in the vicinity of the vehicle 10 with a particular angular frequency or rotational velocity. In exemplary embodiments described herein, one or more of the sensing devices 40a-40n are realized as optical cameras configured to capture images of the environment in the vicinity of the vehicle 10.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

Still referring to FIG. 1, in exemplary embodiments, the communication system 36 is configured to wirelessly communicate information to and from other entities 48, such as but not limited to, other vehicles (“V2V” communication,) infrastructure (“V2I” communication), remote systems, personal devices, and or calibration stations. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 10 (wirelessly and/or in a wired manner) and stored in the data storage device 32. In various embodiments, the data storage device 32 stores calibrations for use in aligning the sensing devices 40a-40n. In various embodiments, one or more of the calibrations are estimated as extrinsic parameter using the methods and systems described herein. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In various embodiments, one or more instructions of the controller 34 are embodied in the control system 100 and, when executed by the processor 44, cause the processor 44 to perform the methods and systems that dynamically align the sensor devices by updating calibrations stored in the data storage device 32 as described in greater detail below.

In accordance with various embodiments, the controller 34 implements an autonomous driving system (ADS). Software and/or hardware components of the controller 34 (e.g., processor 44 and computer-readable storage device 46) are utilized to provide an autonomous driving system that is used in conjunction with vehicle 10, for example, to automatically control various actuators 30 onboard the vehicle 10 to thereby control vehicle acceleration, steering, and braking, respectively, without human intervention.

In various embodiments, the instructions of the autonomous driving system 70 may be organized by function or system. For example, the autonomous driving system can include a computer vision system, a positioning system, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors. In various embodiments, the computer vision system 74 receives information from and/or implements the control system 100 described herein.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

According to some exemplary embodiments, the control system shown generally at 100 is associated with a vehicle 10. In general, the control system 100 selectively aligns two sensors of the vehicle 10 by estimating extrinsic parameters. As will be discussed in more detail, the estimating is based on a method that utilizes a mathematical optimization problem given a group of Lidar-camera control points with a highly flexible 3D-2D correspondence requirement. In various embodiments, the two sensors include a lidar sensor and a camera sensor. As can be appreciated, other sensors can be implemented in various embodiments.

According to some exemplary embodiments, the plurality of sensing devices 40a-40n, the propulsion system 20, the transmission system 22, the steering system 24, the brake system 26, the sensor system 28, the actuator system 30, the at least one data storage device 32, the at least one controller 34, and the communication system 36 are communicatively coupled to transmit data between one another.

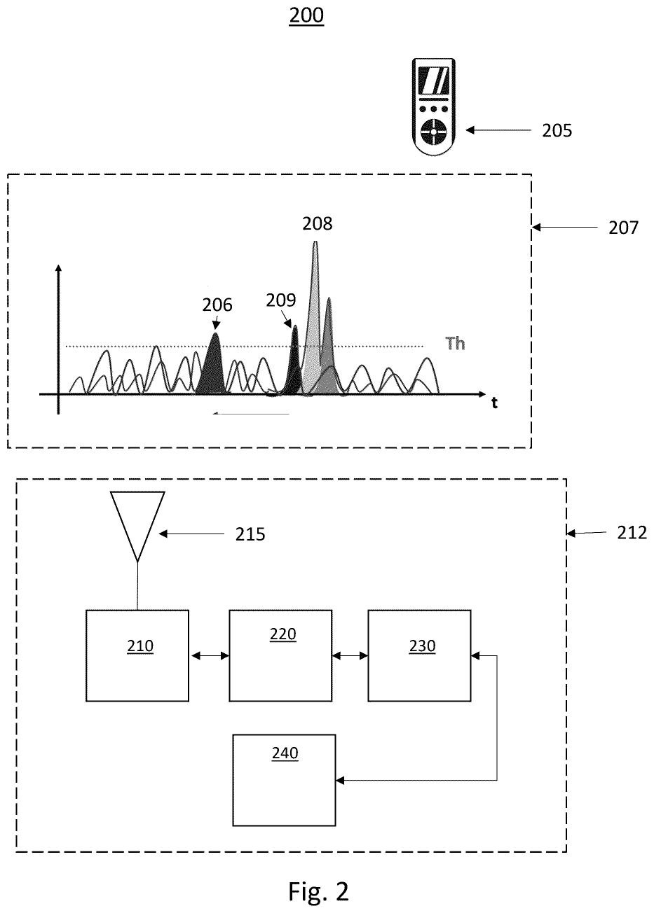

Turning now to FIG. 2, a block diagram illustrating an exemplary implementation of a secure UWB ranging system 200 a motor vehicle data communications system is shown. The exemplary UWB system 200 can include an antenna 215, a transceiver 210, a UWB demodulator/modulator 220, a processor 230 and a vehicle controller 240. In some exemplary embodiments, the antenna 215 can be an antenna array or the like. In some exemplary embodiments, UWB anchors are stationary devices that use multiple antennas to locate other UWB devices, called tags. The exemplary UWB system 200 can be used to proactively identify and mitigate potential HRP UWB distance reduction attacks, such as the ghost peak attack by learning the characteristic signal shape, power distribution, and interference levels associated with various environmental conditions, including open-sky and closed-space environments, weather patterns, and individual user behaviors to detect anomalies that deviate from the expected patterns, indicating potential distance reduction attacks. While the present description is made in the context of automotive applications, but secure ranging and distance reduction attacks can apply in other domains, such as in the context of the smart home where certain functions are activated based on the proximity of the phone, for example to unlock a front door, or a garage door, or tun on the AC or a light etc., or even to locate a lost/misplaced electronic device inside a house or a building. The mitigations we present in this disclosure are relevant to UWB-based ranging regardless of the application domain, automotive and non-automotive. Under some conditions, low-rate pulse repetition frequency (LRP) may also be vulnerable to the ghost peak attack even though in general LRP has more security protections that HRP. In that respect, the presently described mitigations are focused on the less secure HRP in the context of vehicle access applications, but they might also apply to LRP.

The UWB signal can be transmitted and received via a transmitter 205, such as a key fob or mobile device. UWB has become a popular choice for vehicle key fobs and mobile phone security applications due to its high data rate, low power consumption, and ability to penetrate obstacles. However, UWB can be susceptible to distance reduction attacks which are a type of security threat that specifically targets UWB communication systems. By intercepting and manipulating the transmitted UWB signal, malicious actors can introduce delays that cause the receiver to miscalculate the distance between the transmitter and itself which can lead to unauthorized access to restricted areas or devices, as well as other potential security consequences.

In a UWB system 200, a transmitting device, such as the transmitter 205 or the transceiver 210 in the vehicle 212, can generate a short, wide-spectrum pulse a few times per second in order to conserve battery power and to reduce interference with other devices. The pulse travels through the air and reaches the antenna 215 on the vehicle 212. The received signal can then be amplified, filtered, and demodulated to extract the transmitted data. The system can accurately measure the propagation time it takes for the signal to travel from the key fob to the vehicle. This information is used to calculate the distance between the two devices.

To determine the propagation time, the transmitter 205 first generates a scrambled timestamp sequence (STS) based on a shared key in a particular time slot to verify the transmitter's identity and prevent unauthorized access. An STS is a ciphered sequence that ensures the accuracy and integrity of ranging measurement timestamps. It's a key feature of the IEEE 802.15.4z standard that enhances data integrity and provides resiliency against UWB ranging attacks. The transmission of UWB frames may be carried out over a set of frequency channels which the transmitter and receiver use in accordance with the pseudorandom hopping sequence. Typically, once authenticated, the transmitter 205 is authorized to unlock the vehicle 212 or perform other functions. STS sequences comprise a code used in spread spectrum communication systems that involves hopping a narrowband signal across a wide range of frequencies in a pseudorandom manner in order to improve resistance to interference and jamming. The UWB signal can include a front peak 209 and a middle peak 208. The front peak 209 is used for acquisition and synchronization. The front peak 209 is used to establish a timing reference for the receiver, allowing it to accurately decode the incoming signal and can also be employed for ranging, determining the distance between the transmitter and receiver. The Y axis of the graph of FIG. 2 corresponds to the cross-correlation between the received signal and the expected one. The middle peak 208, the highest peak, corresponds to the cross-correlation of the signal obtained from multi-path reflections. The front peak 209, corresponds to the cross-correlation of the signal obtained from direct path. This is also the peak that is relevant for ranging because time-of-flight is measured though the direct path. The middle peak carries the data being transmitted and is modulated to carry the data being transmitted. Common modulation techniques can include Peak Amplitude Modulation (PAM) and Peak Position Modulation (PPM).

In the UWB ranging systems 200, once the max peak from the multipath signal is detected, the received uses the back-search window to look for a smaller leading edge peak that would correspond to the direct path. Once the smaller leading edge peak is found, its location on the time axis provides a timestamp that can be used to estimate the time of flight and hence the distance. The preamble is a specific sequence of peaks or symbols that precedes the actual data transmission. Its primary purpose is to establish synchronization and to estimate transmission channel characteristics, such as attenuation and multipath effects. The front peak 209 is often the first peak or symbol within the preamble. It serves as a strong reference signal for the receiver to detect the presence of the signal and to estimate the timing offset between a local clock and the incoming signal. The middle peak 208 is typically a peak or symbol within the preamble that follows the front peak 209. The middle peak 208 can be used for providing additional information about the channel characteristics, especially for multipath channels and for fine-tuning the timing synchronization. The preamble, front peak 208, and middle peak 209 work together to ensure accurate ranging in UWB systems. By establishing synchronization, estimating channel characteristics, and acquiring the signal, these components enable the receiver to accurately measure the time of flight and determine the distance to the transmitter.

For ranging, the UWB demodulator 220 is operative to demodulate the middle peak 208 to verify the identity of the transmitter 205. The processor 230 can then perform a back search within a search window on the received signal history to determine a time interval between the middle peak 208 and the front peak 209. This time interval is used to determine a distance between the transmitter 205 and the vehicle 212 wherein the earlier arrival time is indicative of a shorter distance between the transmitter 205 and the vehicle 212.

In a ghost attack, a malicious actor transmits UWB signals that cause ghost peak 206 (on the cross-correlation axis) at a point in time earlier than the legitimate peak 209. If the ghost peak 206 is within the search window, a vulnerable system can confuse the ghost peak 206 as the front peak 209. Since this ghost peak 206 is transmitted earlier than the front peak 209, a vulnerable system would determine the range from the transmitter 205 to the vehicle 212 using the ghost peak 206 and assume the transmitter 205 is much closer to the vehicle 212 than the actual transmitter 205. This determined close range may then cause the vulnerable system to allow the vehicle to be unlocked or other secure actions to be performed.

For hardening the UWB system from ghost attacks, the exemplary system 200 can be configured to employ AI algorithm with innovative techniques to proactively identify, detect, and mitigate potential HRP UWB Distance Reduction attacks, including the Ghost Peak Attack. By analyzing the received signals, the algorithm learns the anticipated signal shape, power pattern, and interference levels associated with various factors, including location, weather conditions, and individual user behaviors. The algorithm then detects deviations from these expected patterns, flagging any discrepancies that may indicate an attack. Key parameters examined include the time and power differences between the highest peak and leading edge, as well as the power difference between the leading edge and noise threshold. Any significant deviations from the established norms trigger a security alert, indicating a potential distance reduction attack. This advanced approach ensures robust security and safeguards against the evolving threats posed by these types of attacks.

The security flag initiates the algorithm's proactive response to potential HRP UWB Distance Reduction attacks. Upon detection, the algorithm employs strategic countermeasures, such as skipping the initial suspect leading edge and proceeding to the next or narrowing the search window to half its default size. Following the ranging session, the algorithm validates its detection outcomes through user actions or input, leveraging this feedback to refine its model. The acquired knowledge is then shared with a centralized AI server, which updates the model using aggregated training data to enhance its overall effectiveness in mitigating HRP UWB Distance Reduction attacks.

The AI algorithm employs a dynamic and proactive approach to mitigate HRP UWB distance reduction attacks. By continuously monitoring environmental factors such as location, weather, user behavior, and potential risk levels, the algorithm can adjust parameters like the search window width and noise threshold in real-time. This adaptive strategy helps prevent attackers from exploiting vulnerabilities and ensures the integrity of distance measurements. To assess multipath interference, the algorithm actively emits signals and analyzes reflections, enabling it to refine its mitigation techniques accordingly.

The advanced AI system employs an algorithm that utilizes novel techniques to proactively detect and mitigate potential HRP UWB Distance Reduction attacks, such as the Ghost Peak Attack. By analyzing signal patterns, identifying anomalies, and leveraging user-specific data, threats can be identified and system parameters can be dynamically adjusted to prevent unauthorized access. Post-incident assessments further enhance threat detection capabilities, ensuring continuous improvement and adaptation to evolving security challenges. Through a collaborative learning approach, shared data across multiple vehicles can enhance the system's overall resilience and adaptability. This enables the AI algorithm to identify emerging threats and develop countermeasures more efficiently. Additionally, the AI system's ability to dynamically adjust the search window and noise threshold ensures optimal performance in various environmental conditions, further strengthening our security posture.

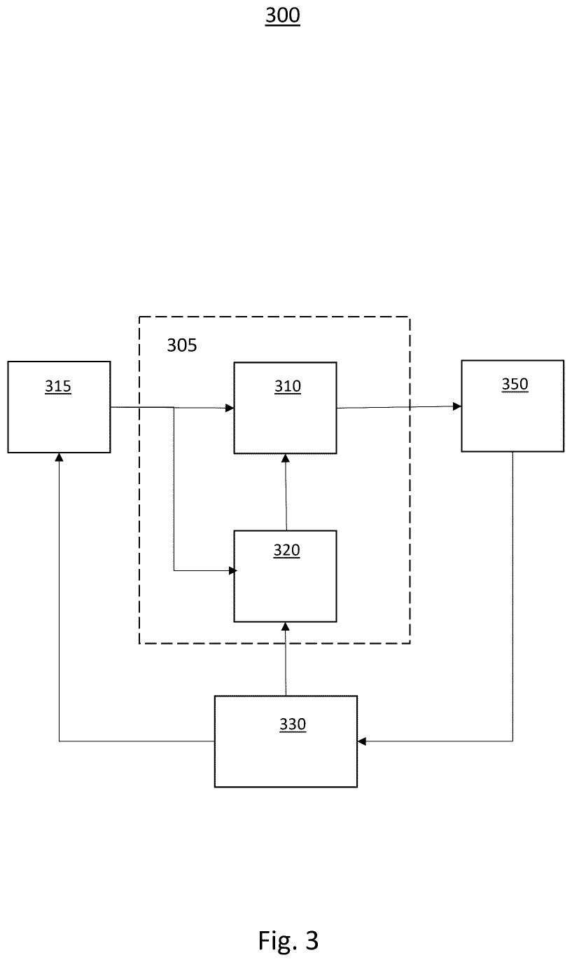

Turning now to FIG. 3, a functional block diagram illustrating an exemplary implementation of a secure UWB ranging system 300 a motor vehicle data communications system in accordance with embodiments of the present disclosure is shown. The diagram illustrates a reinforcement learning-based AI algorithm designed to enhance the security of UWB ranging systems against ghost attacks. This agent-based approach enables the vehicle to dynamically adapt its response strategies to evolving threat scenarios.

UWB range ghost attacks pose a significant threat to the security of UWB systems, exploiting vulnerabilities in the HRP layer to manipulate distance measurements. These attacks, which involve the introduction of false signals or the manipulation of legitimate ones, can lead to unauthorized access or compromised security. To counter these threats, a reinforced learning algorithm is provided which employs advanced techniques to analyze signal characteristics, detect anomalies, and dynamically adjust system parameters. By proactively identifying and mitigating potential attacks, the integrity and security of UWB-based applications is ensured.

The vehicle 305 continuously observes 315 the signal phase, distance, and/or amplitude, identifying deviations from the expected baseline as potential threats. Based on the observed data, the policy 310 determines the optimal mitigation strategy. This policy 310 is learned through a reinforcement learning algorithm 320. The observations 315 are also supplied to the reinforced learning algorithms 320. The reinforcement learning algorithm iteratively refines the policy based on the outcomes of actions, ensuring continuous improvement. Learning updates are supplied to the policy 310 based on the updated reenforced learning algorithms 320.

In response to the policy 310, the vehicle control system then responds to the detected threat by initiating appropriate device-vehicle ranging threat mitigation measures. The environment 330 represents the external factors that influence the signal and the effectiveness of the mitigation measures, including noise, interference, and potential ghost attacks. In response to the environment 330 and the action 350, a reward function evaluates the effectiveness of the vehicle's response based on the response time and the phase of the peaks. Timely threat mitigation and accurate phase alignment are prioritized. Through this iterative process, the algorithm learns the optimal policy by interacting with the environment, receiving rewards for successful actions and penalties for unsuccessful ones. By employing this AI-driven approach, the vehicle can effectively learn from its experiences, adapt to changing threat landscapes, and proactively mitigate ghost attacks, thereby ensuring the integrity and security of UWB ranging systems.

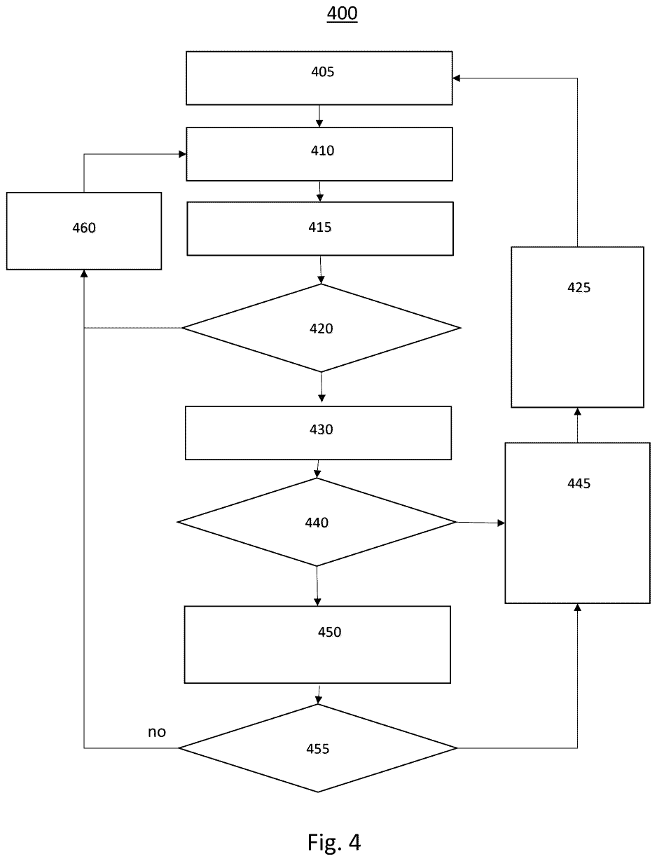

Turning now to FIG. 4, a flow chart illustrating an exemplary implementation of a method 400 for a secure UWB ranging system a motor vehicle data communications system is shown. The method 400 is first operative to store 405 data representative of characteristics of an STS peak from an authenticated transmitter. These characteristics can include time difference and power difference between highest peak and leading edge, power difference between the leading edge and the noise threshold, shape, maximum amplitude and power distribution of the front peak.

The method 400 is next operative to receive 410 an STS sequence from a remote transmitter. The method 400 decodes 415 the STS peak and determines if the transmitter is an authenticated transmitter. In some exemplary embodiments, the transmitter can be authenticated in response to a common key or the like. If the transmitter is not authenticated 420, the method 400 rejects 460 the STS sequence and returns to receiving a subsequent STS sequence 410.

If the STS sequence is successfully authenticated 420, the method 400 then compares 430 the front peak of the received STS sequence to the stored front peak. In some exemplary embodiments, the receiver can perform the comparison through cross-correlations of the received signal and the expected one. If the value of the cross correlation is high, such as above a certain threshold, that indicates the max peak which corresponds to the multipath signal. If the cross-correlation does not reach the threshold, that means the received STS is wrong or contains too many errors. Once the max peak is found, the receiver can use the back search window to look for the leading edge peak, which corresponds to direct path. The method 400 can compare the peak shape, the differences in signal strength of the front peak compared to the middle peak, power distribution and/or power difference between the leading edge and the noise threshold. If the first peak matches the stored first peak 440, the method 400 then determines a distance 445 between the transmitter and the vehicle in response to a timing of the front peak. For example, the method can save the received sequence, authenticate the STS sequence in response to data transmitted in the middle peak and then calculates the time difference between the arrival of the first peak and the middle peak in the sequence. This time difference is directly proportional to the distance between the transmitter and receiver. In response to the detected time and the authentication of the transmitter, the method 400 then authorizes 445 actions based on the distance, such as unlocking the vehicle, remote start, transition from standby to drive mode and the like. The method 400 can then update the front peak characteristics 425 of the front peak stored in memory in response to the newly received front peak. The method then stores 405 the updated front peak in the memory to be used for further ranging system security.

If the front peak and the stored front peak do not match 440, the method can then take countermeasures to detect a front peak from the authenticated transmitter. In some exemplary embodiments, the method 400 can reduce the back search time window 450 for detecting the front peak. Thus, the method 400 only looks back a reduced amount of time from the time of the authenticated middle peak to detect the front peak. This window can be repeatedly reduced until a matching front peak is detected. If a new matching front peak is detected 455, the method 400 then determines the distance between the transmitter and the vehicle and authorizes actions based on that distance. If a new matching peak is not detected 455, the method 400 can then reject 460 the STS sequence and return to receiving a next STS sequence 410.

In some exemplary embodiments, when the initial front peak is determined not to be a match 440, the method 400 can employ pattern recognition and self-learning, such as from signal shape, integrity, characteristics tied with unique location/events/user-specifics, to detect a match of the front peak to the stored front peak. The method 400 may use location and location characteristics, such as open sky, dense urban area, closed space, weather conditions, user habits and potential risk to predicted multipath signals and possible threat conditions. In some exemplary embodiments, the back search window depends on the maximum delay between the multipath signal and the direct path signal. And that delay, in turn, depends on space in which the measurement is made, such as open sky, dense urban area, weather conditions, temperature, humidity, etc. The optimal width of the search window for each of those cases can be learned by an AI model, and set by the vehicle and keyfob/phone, or more generally the transmitter and receiver in a ranging session, to the right/optimal value. The method 400 can employ threat detection, such as detecting threat using the training set and inconsistencies with patterns developed specific to user/location/time of day/weather conditions, and threat mitigation by dynamically adjusting system parameters to defend against attacks and threat assessment by using post incident actions to determine if a threat was credible. In addition, the method 400 may employ shared learning, or crowdsource, to upload threat data to a centralized database which can be used by all vehicles. The method 400 may proactively and dynamically adjust the width of the back search window, adjust the noise threshold and sense the environment and environmental conditions to determine optimal/more secure system parameters. The method 400 can proactively & dynamically adjust the noise threshold based on factors such as amount of fading and multipath interference. In some exemplary embodiments, the method 400 can estimate a level of multipath interference by sensing its environment, by emitting a signal and measuring the reflected signal characteristics.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for determining a distance between a transmitter and a receiver comprising:
storing, in a memory, a first data indicative of characteristics of an expected peak;
receiving, by the receiver, a data sequence including a first peak and a second peak;
authenticating, by a processor, the data sequence in response to a second data received in the second peak;
determining, by the processor, the distance between the transmitter and the receiver in response to a difference between a first time of reception of the first peak and a second time of reception of the second peak, wherein a determination of the distance is initiated in response to the first peak matching the expected peak; and
enabling, by a vehicle controller, a vehicle control algorithm in response to the distance.

2. The method for determining the distance between the transmitter and the receiver of claim 1 wherein a search time interval for detecting a subsequent first peak is reduced in response to the first peak not matching the expected peak.

3. The method for determining the distance between the transmitter and the receiver of claim 1 wherein the first peak and the second peak are a portion of a pseudorandom spread spectrum time hopping sequence.

4. The method for determining the distance between the transmitter and the receiver of claim 1 wherein the vehicle control algorithm includes unlocking a vehicle and transitioning the vehicle between a standby state and an on state.

5. The method for determining the distance between the transmitter and the receiver of claim 1 wherein a search time interval for detecting a subsequent first peak is reduced in response to the first peak not matching the expected peak, and wherein a duration of the search time interval is determined in response to a vehicle location, a vehicle environment, a weather condition, a user habit and a potential risk level.

6. The method for determining the distance between the transmitter and the receiver of claim 1 wherein a search time interval for detecting a subsequent first peak is reduced in response to the first peak not matching the expected peak, and wherein a duration of the search time interval is determined in response to a level of multipath estimated in response to transmitting a signal and detecting a reflection of the signal by a vehicle communications system.

7. The method for determining the distance between the transmitter and the receiver of claim 1 wherein a search time interval for detecting a subsequent first peak is reduced in response to the first peak not matching the expected peak, and wherein a duration of the search time interval is reduced in response to a length of pseudorandom spread spectrum time hopping sequence preamble in a time domain.

8. The method for determining the distance between the transmitter and the receiver of claim 1 wherein the first peak is rejected in response to the first peak not matching the expected peak and a subsequent peak is detected between the first peak and the second peak wherein the subsequent peak is then compared to the expected peak.

9. The method for determining the distance between the transmitter and the receiver of claim 1 wherein a power difference between the first peak and the second peak is used to compare the first peak to the expected peak.

10. An apparatus for determining a distance between a transmitter and a receiver comprising:
a memory configured for storing a first data indicative of characteristics of an expected peak;
the receiver configured for receiving a data sequence including a first peak and a second peak from the transmitter;
a processor configured for authenticating the data sequence in response to a second data received in the second peak, for determining the distance between the transmitter and the receiver in response to a difference between a first time of reception of the first peak and a second time of reception of the second peak, wherein a determination of the distance is initiated in response to the first peak matching the expected peak, and for generating a control signal in response to the distance; and
a vehicle controller for enabling a vehicle control algorithm in response to the control signal.

11. The apparatus for determining the distance between the transmitter and the receiver of claim 10 wherein the processor is further configured to reduce a search time interval for detecting a subsequent first peak in response to the first peak not matching the expected peak.

12. The apparatus for determining the distance between the transmitter and the receiver of claim 10 wherein the processor is further configured to reduce a search time interval for detecting a subsequent first peak in response to the first peak not matching the expected peak, and wherein a duration of the search time interval is determined in response to a vehicle location, a vehicle environment, a weather condition, a user habit and a potential risk level.

13. The apparatus for determining the distance between the transmitter and the receiver of claim 10 wherein the processor is further configured to reduce a search time interval for detecting a subsequent first peak in response to the first peak not matching the expected peak, and wherein a duration of the search time interval is determined in response to a level of multipath estimated in response to transmitting a signal and detecting a reflection of the signal by a vehicle communications system.

14. The apparatus for determining the distance between the transmitter and the receiver of claim 10 wherein the processor is further configured to reduce a search time interval for detecting a subsequent first peak in response to the first peak not matching the expected peak, and wherein a duration of the search time interval is reduced in response to a length of pseudorandom spread spectrum time hopping sequence preamble in a time domain.

15. The apparatus for determining the distance between the transmitter and the receiver of claim 10 wherein the first peak is rejected in response to the first peak not matching the expected peak and a subsequent peak is detected between the first peak and the second peak wherein the subsequent peak is then compared to the expected peak.

16. The apparatus for determining the distance between the transmitter and the receiver of claim 10 wherein a power difference between the first peak and the second peak is used to compare the first peak to the expected peak.

17. The apparatus for determining the distance between the transmitter and the receiver of claim 10 wherein the first peak and the second peak are a portion of a pseudorandom spread spectrum time hopping sequence.

18. The apparatus for determining the distance between the transmitter and the receiver of claim 10 wherein the vehicle control algorithm includes unlocking a vehicle and transitioning the vehicle between a standby state and an on state.

19. A vehicle communications system comprising:
a transmitter having a first memory for storing a shared key and for transmitting a pseudorandom spread spectrum time hopping sequence including a first peak and a second peak and wherein the second peak is generated in response to the shared key;
a second memory for storing, a first data indicative of a plurality of characteristics of an expected peak wherein the plurality of characteristics include a time difference between the first peak and the second peak, a first power difference between the first peak and the second peak, and a second power difference between a leading edge of the first peak and a noise threshold;
a receiver for receiving the pseudorandom spread spectrum time hopping sequence including the first peak and the second peak;
a processor configured for authenticating the pseudorandom spread spectrum time hopping sequence in response to the second peak and the shared key, for determining a distance between the transmitter and the vehicle communications system in response to a difference between a first time of reception of the first peak and a second time of reception of the second peak, wherein a determination of the distance is initiated in response to the first peak matching the expected peak; and
a vehicle controller configured for enabling a vehicle control algorithm in response to the distance and for controlling a vehicle in response to the vehicle control algorithm.

20. The vehicle communications system of claim 19, wherein a search time interval for detecting a subsequent first peak is reduced in response to the first peak not matching the expected peak, and wherein a duration of the search time interval is determined in response to a vehicle location, a vehicle environment, a weather condition, a user habit, a potential risk level, a length of pseudorandom spread spectrum time hopping sequence preamble in a time domain, and a level of multipath estimated in response to transmitting a signal and detecting a reflection of the signal by the vehicle communications system.
